(19) United States
(12) Patent Application Publication
(10) Pub. No.: US 2010/0062136 A1
(43) Pub. Date: Mar. 11, 2010

(54) FRENCH FRY PARFRY OIL FOR REDUCED FREEZER CLUMPING

(75) Inventors: Michael L. Hamann, Caldwell, ID (US); Jeffrey L. Henderson, Nampa, ID (US)

Correspondence Address: KELLY LOWRY & KELLEY, LLP, 6320 CANOGA AVENUE, SUITE 1650, WOODLAND HILLS, CA, 91367, US

(73) Assignee: J.R. SIMPLOT COMPANY, Boise, ID (US)

(21) Appl. No.: 12/551,817

(22) Filed: Sep. 1, 2009

Related U.S. Application Data
(60) Provisional application No. 61/094,446, filed on Sep. 5, 2008.

(51) Int. Cl. A23D 9/00; A23L 1/216; A23L 1/217

(52) U.S. Cl. 426/607; 426/438; 426/441

(57) ABSTRACT

An improved parfry oil blend and related production process for parfrying vegetable pieces particularly such as French fry potato strips followed by freezing for packaging, storage and/or shipment before finish preparation, wherein the parfry oil blend reduces post-parfry freeze clumping. The improved oil blend comprises a substantially fully hydrogenated hard stock component selected from the group consisting essentially of cottonseed and palm oils at a proportion of less than 11% and preferably about 8-10% by weight. This hard stock component is blended with a liquid stock component such as a zero grams trans fat (ZGTF) liquid oil such as soy, canola, safflower, and the like. When potato strips are parfried in this improved oil blend, and then frozen, freezer clumps are substantially eliminated.

### BACKGROUND OF THE INVENTION

This invention relates generally to an improved parfry oil blend and related production process wherein parfried vegetable pieces such as elongated French fry potato strips are frozen substantially in the absence of undesirable freezer clumping. More specifically, this invention relates to an improved parfry oil blend and related production process, wherein the oil blend comprises a minor proportion of an oil hard stock component selected specifically for substantial elimination of post-parfry freeze clumping, in combination with a major proportion of an oil liquid stock component selected for substantially zero grams trans fat (ZGTF) characteristics.

Parfried and frozen vegetable pieces such as elongated potato strips, commonly referred to as French fries, are widely available in the foods industry. These potato products are conventionally prepared by cutting whole potatoes into elongated strips of a desired size and shape, and then partially cooking the potato strips by blanching in hot water or steam. Thereafter, the potato strips are typically dewatered or partially dried, followed by partial frying, or parfrying, in hot cooking oil. The parfried potato strips are then frozen for packaging, shipping and/or storage. Prior to consumption, the parfried and frozen potato strips are reconstituted or finish prepared typically by finish frying in hot oil. French fried potato strips of this type are utilized extensively in restaurant and food service operations, and particularly in so-called fast food restaurants wherein it is desirable to produce a finish cooked product with a substantially optimized set of taste, texture, and appearance quality characteristics, and with a relatively short finish fry preparation time. Further details of one exemplary French fry production process are described in U.S. Pat. No. 3,397,993, which is incorporated by reference herein.

Post-parfry freezing of the potato strips normally occurs under so-called blast freeze conditions, wherein the parfried strips are cooled and frozen as they are conveyed through a freezer tunnel or the like toward appropriate packaging equipment which then packs the parfried and frozen strips for subsequent shipment and/or frozen storage to await finish preparation. Such freezer apparatus typically lowers the temperature of the parfried strips over a period of at least several minutes, with the packaging step normally taking place when the parfried strips are at a temperature of about 10 to about 25 F., followed by further strip temperature reduction to a target freezer temperature of at least about 0 F., and which can be as low as about −20 F.

Recent nutritional research has resulted in parfry oil modifications, particularly with respect to reducing levels of saturated and/or trans fats therein. In this regard, traditional parfry oils have in the past comprised a blend of one or more so-called hard stock components having a relatively high crystallization temperature in combination with one or more so-called liquid stock components having a relatively low crystallization temperature. The hard stock component normally exhibits a relatively solid or semi-solid state at room temperature, and is typically produced by partially or substantially fully hydrogenating a selected liquid stock oil component. By contrast, the liquid stock component normally exhibits a liquid state at room temperature. When mixed together in selected proportions, the resultant solid-liquid oil blend exhibits a soft or semi-solid, substantially shortening-like consistency at room temperature.

Hydrogenation of a liquid stock oil component to produce a hard stock oil component is known to result in the presence of trans-fats (in the case of partial hydrogenation) and/or saturated fats (in the case of substantially full or complete hydrogenation). Current nutritional trends have sought to reduce the level of trans-fats and/or saturated fats in food products, whereby alternative parfry oils have been proposed and are currently in use of a type commonly known as zero grams trans-fat (ZGTF) oils. However, such ZGTF oils have by necessity been primarily or entirely formed from a non-hydrogenated liquid stock oil component or components, whereby such ZGTF oils have inherently exhibited a relatively low crystallization temperature.

One major drawback encountered with liquid stock parfry oils of the above-described ZGTF type relates to significant freezer clumping of the parfried pieces, wherein the low crystallization temperature of the liquid stock parfry oil (on the surfaces of the parfried strips) is believed to crystallize or freeze at a low temperature reached only after the parfried and frozen strips have been assembled into the appropriate sized packages. Alternately, during the product shipment and/or storage phase, the parfried and frozen strips may be subjected to a varying freezer temperature, with at least brief intervals wherein the freezer temperature is higher than the crystallization temperature of the parfry oil. In either case, the packed parfried and frozen strips tend to adhere in groups or clumps which must be broken apart before finish preparation. Such clump breakage inherently involves a manual labor step before the frozen strips can be finish prepared at a restaurant facility or the like, and further subjects the frozen strips to potentially undesirable and unsightly damage.

One theoretical resolution to this freezer clumping problem is to lower the temperature level of the parfried strips below the oil crystallization temperature in the post-parfry freezer tunnel or the like, before the individual strips are packaged. Such technique, however, requires a significant increase in freezer tunnel length and/or pre-package freezer time with an inherent increase in production time and cost. In addition, such technique does not prevent subsequent exposure of the packaged strips to a freezer temperature higher than the crystallization temperature of the parfry oil, such as during product transfer between frozen storage at a production facility to frozen storage at a restaurant facility or the like. In such event, undesirable freezer clumping of the packaged strips can still occur.

There exists, therefore, a significant need for an improved parfry oil blend and related production process utilizing this improved parfry oil blend, wherein this improved oil blend exhibits substantially ZGTF characteristics but does not encounter significant undesirable freezer clumping of the parfried and frozen strips during packaging, shipment and/or storage awaiting finish preparation. The present invention fulfills all of these needs, and provides further related advantages.

### SUMMARY OF THE INVENTION

In accordance with the invention, an improved parfry oil blend and related production process are provided for parfrying vegetable pieces particularly such as French fry potato strips wherein the parfried pieces are subsequently frozen for packaging, storage and/or shipment substantially in the absence of freezer clumping.

The production process comprises initial cutting of raw potatoes in a peeled or unpeeled state into individual pieces of selected size and shape, such as elongated French fry strips. These cut pieces are then partially cooked by conventional blanching in hot water or steam, followed by appropriate de-watering and/or drying steps. The blanched pieces are then partially fried or parfried in hot oil, wherein the parfry oil comprises a blend of a hard stock component such as substantially fully hydrogenated cottonseed and/or palm oil, in combination with a liquid stock component such as a zero grams trans fat (ZGTF) oil such as soy, canola, safflower, and the like. In a preferred form, the parfry oil comprises the hard stock component at a proportion of less than 11% and preferably about 8-10% by weight, with the balance comprising the liquid stock component.

The parfried pieces are then frozen as by conveyance into and/or through a freezer tunnel for quickly reducing the temperature thereof to an intermediate freezer temperature, such as on the order of about 10 to about 25 F. These parfried and frozen pieces are then packaged for storage and/or shipment, followed by further strip temperature reduction to a target freezer temperature of at least about 0 F., and which can be as low as about −20 F.

Upon finish preparation, such as by finish frying at a restaurant facility or the like, the frozen piece packages are opened. In accordance with the invention, the parfried and frozen potato pieces, upon package opening, exhibit substantially no freezer clumping. Instead, the frozen pieces comprise individually separable parfried pieces which can be finish prepared, as by finish frying or the like, substantially without requiring clump separation and/or post-freeze product breakage.

Other features and advantages of the invention will become more apparent from the following detailed description.

### DETAILED DESCRIPTION OF THE PREFERRED EMBODIMENTS

The present invention relates to an improved parfry oil blend and a related production process wherein parfried vegetable pieces such as French fry potato strips are frozen for packaging, shipment and/or storage, substantially in the absence of undesirable freezer clumping. In general terms, the parfry oil blend comprises a relatively minor proportion of a specific hard stock oil component, such as a substantially fully hydrogenated cottonseed oil and/or palm oil, in combination with a relatively major proportion of a liquid stock oil component having substantially zero grams trans fat (ZGTF) characteristics.

More particularly, in accordance with a preferred production process utilizing the improved parfry oil blend, vegetable products such as raw potatoes are initially cut in a peeled or optionally unpeeled state into individual pieces such as elongated French fry potato strips having a selected cross sectional size and shape. In one preferred form, the cut pieces are shoestring-size strips having a square-cut cross sectional dimension of approximately 0.25 to about 0.30 inch per side. These French fry strips are initially blanched in hot water or steam, in accordance with conventional French fry processing techniques and time/temperature parameters suitable for strip size. The blanched strips are then dewatered and optionally partially dried before parfrying in the improved parfry oil blend of the present invention. One exemplary process for cutting, blanching and partially drying such potato strips before parfrying is disclosed in U.S. Pat. No. 3,397,993, which is incorporated by reference herein.

In general terms, the blanched potato strips are parfried in the hot oil for a time and temperature selected according to strip size and shape, for partially cooking the strips before freezing. Exemplary parfry conditions are also described in the above-cited U.S. Pat. No. 3,397,993. The parfried strips are then frozen typically by conveyance through a freezer tunnel or the like prior to packaging into lots of selected mass for convenient shipment and/or storage to await finish preparation. A typical production freeze process entails initial reduction of the parfried strips to a temperature of from about 10 F. to about 25 F., and preferably less than about 16 F., followed by the packaging step. After packaging, the strip temperature is normally lowered further to at least about 0 F., and preferably on the order of about −20 F.

The improved parfry oil blend of the present invention comprises a specific blend of hard and liquid stock oil components chosen to provide an overall parfry oil having highly desirable nutritional properties in combination with reducing and/or eliminating undesirable freeze clumping of the parfried and frozen packaged strips. Accordingly, the improved oil blend beneficially and substantially complies with modern nutritional demands particularly with respect to exhibiting substantially ZGTF characteristics in combination with minimal presence of saturated fats, while substantially eliminating freezer clumping and accompanying labor costs and/or potential product breakage damage associated therewith.

Specifically, the improved parfry oil blend of the present invention comprises a hard stock oil component selected from a particular group of oils which have been found to substantially eliminate undesirable freeze clumping, while providing a minimal and significantly reduced range of saturated fats in the final oil blend. Such hard stock oil component, in one preferred form, comprises cottonseed oil which has been substantially fully hydrogenated from a liquid state to an Iodine value of 10 or less. Such hydrogenated cottonseed oil is used in the parfry oil blend in a minor proportion, namely, less than 11% by weight, and more preferably on the order of about 8-10% by weight.

Alternative oils can be used as the hard stock oil component in the present invention, including palm oil which has also been substantially fully hydrogenated, or a blend of cottonseed and palm oils. By contrast, a large number of conventional cooking oils have been found to be unsuitable for use as the hard stock component of the improved parfry oil blend of the present invention, such as soy, canola, corn, and the like. At present, as best understood, the reason why cottonseed and/or palm hard stock oil components function properly in the present invention, whereas other hard stock oil components produced from soy, canola, corn and like do not function to reduce or eliminate freeze clumping is believed to be attributable to differences in the fatty acid compositions of the respective oils. These differences in fatty acid composition have a direct impact on the crystal structure of the hard stock. It is believed that the crystal structure in combination with the crystallization temperature makes the hard stock function correctly (e.g., cottonseed and/or palm oil) or incorrectly (e.g., soy, canola, and others) as required in accordance with the present invention.

The selected hard stock oil component is blended in a minor proportion with a selected liquid stock oil component, particularly such as a traditional ZGTF liquid-type oil component such as soy or canola or the like. In the preferred form, the selected hard stock oil component is provided in a minor proportion of less than about 11% by weight, and more preferably about 8-10% by weight, with the balance of the oil blend comprising the ZGTF liquid stock oil component. Within this blend, the hard stock oil component has a relatively high crystallization temperature and is substantially in a solid or semi-solid state at room temperature, whereas the liquid stock oil component has a relatively low crystallization temperature typically less than about 10-25 F. When blended together in these proportions, the oil blend has a soft or semi-solid constituency at room temperature.

Following parfrying of the elongated French fry strips in the improved oil blend of the present invention, the strips are conveyed to and through a freezer. According to conventional production techniques, the freezer reduces the temperature of the parfried strips over a period of at least several minutes. When the strips are frozen albeit to an intermediate freezer temperature within a range of from about 10 to about 25 F., and more preferably less than about 16 F., the strips are packaged into lots of selected mass, typically by packaging the strips into paper-based cartons or bags which are then assembled into larger boxes for convenient shipment and/or storage under freezer conditions. Desirably, following packaging, the strips are further reduced in temperature to at least about 0 F., and more preferably about −20 F.

The frozen and packaged strips, when parfried in the improved oil blend of the present invention, do not encounter any significant freeze clumping, despite the fact that the crystallization temperature of the liquid stock oil component is relatively low. Rather, the presence of the selected hard stock oil component, in minor proportion, reduces or eliminates undesirable freezer clumping, notwithstanding periodic freezer temperature variations and fluctuations which may be encountered, e.g., as the packaged strips are transferred from frozen storage at a production facility to frozen storage at a restaurant or the like to await finish preparation.

The parfried and frozen French fry strips are typically finish prepared by finish frying in hot oil, and then served to consumers within a few minutes after the finish fry preparation step. In this regard, the individual packages of the parfried and frozen strips are opened and typically poured directly while in the frozen state into pre-heated finish fry cooking oil. Importantly, in accordance with the invention, the parfried and frozen strips encounter virtually no undesirable freezer clumping, whereby the individual strips can be poured directly from the package into the finish fry cooking oil, without requiring undesirable freezer clumps to be separated.

A variety of further modifications and improvements in and to the improved parfry oil blend and related production process of the present invention will be apparent to those skilled in the art. Accordingly, no limitation on the invention is intended by way of the foregoing description, except as set forth in the appended claims.

What is claimed is:

1. A blended parfry oil for use in parfrying French fry potato strips prior to freezing, wherein freeze clumping of parfried strips is substantially eliminated, said blended parfry oil comprising:
a hard stock oil component comprising a substantially fully hydrogenated oil having a relatively high crystallization temperature and exhibiting a substantially solid state at room temperature, and further having an Iodine value of not greater than about 10; and
a substantially zero grams trans fat (ZGTF) liquid stock oil component having a relatively low crystallization temperature and exhibiting a substantially liquid state at room temperature;
said hard stock oil component being blended together with said liquid stock oil component in a minor proportion of less than about 11% by weight of the blended parfry oil, with said liquid stock oil component comprising the balance of the blended parfry oil, whereby the blended parfry oil exhibits a semi-solid constituency at room temperature.

2. The blended parfry oil of claim 1 wherein said hard stock oil component is selected from the group consisting essentially of cottonseed and palm oil, and mixtures thereof.

3. The blended parfry oil of claim 1 wherein said liquid stock oil component is selected from the group consisting essentially of soy, canola, and safflower oils, and mixtures thereof.

4. The blended parfry oil of claim 1 wherein said hard stock oil component is blended with said liquid stock oil component in a minor proportion ranging from about 8% to about 10% by weight of the blended parfry oil.

5. The blended parfry oil of claim 1 wherein said relatively low crystallization temperature of said liquid stock oil component is within the range of from about 10° to about 25° F.

6. A blended parfry oil for use in parfrying French fry potato strips prior to freezing, wherein freeze clumping of parfried strips is substantially eliminated, said blended parfry oil comprising:
a hard stock oil component comprising a substantially fully hydrogenated oil having a relatively high crystallization temperature and exhibiting a substantially solid state at room temperature, and further having an Iodine value of not greater than about 10;
said hard stock oil component being selected from the group consisting essentially of cottonseed and palm oils, and mixtures thereof; and
a substantially zero grams trans fat (ZGTF) liquid stock oil component having a relatively low crystallization temperature and exhibiting a substantially liquid state at room temperature;
said hard stock oil component being blended together with said liquid stock oil component in a minor proportion of less than about 11% by weight of the blended parfry oil, with said liquid stock oil component comprising the balance of the blended parfry oil, whereby the blended parfry oil exhibits a semi-solid constituency at room temperature.

7. The blended parfry oil of claim 6 wherein said hard stock oil component is blended with said liquid stock oil component in a minor proportion ranging from about 8% to about 10% by weight of the blended parfry oil.

8. A blended parfry oil for use in parfrying vegetable pieces potato strips prior to freezing, wherein freeze clumping of parfried pieces is substantially eliminated, said blended parfry oil comprising:
a hard stock oil component comprising a substantially fully hydrogenated oil having a relatively high crystallization temperature and exhibiting a substantially solid state at room temperature, and further having an Iodine value of not greater than about 10; and
a substantially zero grams trans fat (ZGTF) liquid stock oil component having a relatively low crystallization temperature and exhibiting a substantially liquid state at room temperature;
said hard stock oil component being blended together with said liquid stock oil component in a minor proportion of less than about 11% by weight of the blended parfry oil, with said liquid stock oil component comprising the balance of the blended parfry oil, whereby the blended parfry oil exhibits a semi-solid constituency at room temperature.

9. The blended parfry oil of claim 8 wherein said hard stock oil component is selected from the group consisting essentially of cottonseed and palm oil, and mixtures thereof.

10. The blended parfry oil of claim 8 wherein said liquid stock oil component is selected from the group consisting essentially of soy, canola, and safflower oils, and mixtures thereof.

11. The blended parfry oil of claim 8 wherein said hard stock oil component is blended with said liquid stock oil component in a minor proportion ranging from about 8% to about 10% by weight of the blended parfry oil.

12. In a production process for parfrying French fried potato strips comprising the steps of blanching raw cut potato strips, parfrying the blanched potato strips, and freezing the parfried potato strips to await finish preparation for consumption, the improvement comprising the step of:
parfrying the potato strips in a blended parfry oil comprising a substantially fully hydrogenated hard stock oil component having a relatively high crystallization temperature and exhibiting a substantially solid state at room temperature and further having an Iodine value of not greater than about 10, and a substantially zero grams trans fat (ZGTF) liquid stock oil component having a relatively low crystallization temperature and exhibiting a substantially liquid state at room temperature;
said hard stock oil component being blended together with said liquid stock oil component in a minor proportion of less than about 11% by weight of the blended parfry oil, with said liquid stock oil component comprising the balance of the blended parfry oil, whereby the blended parfry oil exhibits a semi-solid constituency at room temperature, and further wherein freeze clumping of the parfried potato strips is substantially eliminated.

13. The process of claim 12 wherein said hard stock oil component is selected from the group consisting essentially of cottonseed and palm oil, and mixtures thereof.

14. The process of claim 12 wherein said liquid stock oil component is selected from the group consisting essentially of soy, canola, and safflower oils, and mixtures thereof.

15. The process of claim 12 wherein said hard stock oil component is blended with said liquid stock oil component in a minor proportion ranging from about 8% to about 10% by weight of the blended parfry oil.
